(19) United States
(12) Patent Application Publication
(10) Pub. No.: US 2024/0186634 A1
(43) Pub. Date: Jun. 6, 2024

(54) BATTERY POWERED DEVICE AND MECHANISM FOR ENGAGING BATTERY

(71) Applicant: 3M INNOVATIVE PROPERTIES COMPANY, St. Paul, MN (US)

(72) Inventors: Yi-Chi Huang, Santa Clara, CA (US); Jacob H. Ely, Carmel, IN (US); Ravi Thomas, Avon, IN (US)

(21) Appl. No.: 18/550,749

(22) PCT Filed: Mar. 17, 2022
(86) PCT No.: PCT/US2022/020747

§ 371 Date: Sep. 15, 2023

Related U.S. Application Data
(60) Provisional application No. 63/265,578, filed on Dec. 17, 2021.
(60) Provisional application No. 63/162,340, filed on Mar. 17, 2021.

(51) Int. Cl. H01M 50/247; H01M 50/244; H01M 50/503; H01M 50/519; H01M 50/588; H01M 50/593

(52) U.S. Cl. CPC H01M 50/247; H01M 50/244; H01M 50/503; H01M 50/519; H01M 50/588; H01M 50/593

(57) ABSTRACT

A battery-powered system includes a device and a battery. The device includes a recess for receiving the battery and an electrical contact disposed at the bottom of the recess. The device includes front and back guide elements and a spacer with a raised portion and a ramp. The battery has front and back guide elements constructed to mate with corresponding front and back guide elements of the device such that when the guide elements are mated, the battery is in a locked position. A battery electrical contact is disposed along the device-facing major surface, constructed to operatively couple with the device electrical contact. The spacer is constructed to reduce wear and damage to the electrical contacts by reducing contact with the electrical contacts while the battery is moved long the spacer.

### RELATED APPLICATIONS

This application claims priority to U.S. Provisional Application No. 63/162,340 filed Mar. 17, 2021 entitled BATTERY ENGAGEMENT WITH SLIDE AND LOCKING MECHANISM and U.S. Provisional Application No. 63/265,578 filed Dec. 17, 2021 entitled BATTERY POWERED DEVICE AND MECHANISM FOR ENGAGING BATTERY both of which are incorporated herein in their entireties.

### FIELD

The present disclosure relates to a slide mechanism for removably attaching a battery to an electrically powered device.

### SUMMARY

A battery-powered system is disclosed, including a device and a battery for supplying power to the device. The device includes a recess for receiving the battery, the recess defining a bottom and opposing first and second sides. The device includes an electrical contact disposed at the bottom of the recess. Disposed at each of the first and second sides are a front guide element, a back guide element, and a spacer. The spacer includes a raised portion aligned with the device electrical contact and a first ramp disposed between the raised portion and the front guide element. The battery defines a front end, a back end opposite of the front end, opposing first and second sides, and a device-facing major surface. Disposed at each of the first and second sides of the battery, a front guide element and a back guide element are provided. The front and back guide elements of the battery are constructed to mate with the corresponding front and back guide elements of the device, respectively, such that when the front and back guide elements are mated, the battery is in a locked position. The battery further includes an electrical contact disposed along the device-facing major surface, constructed to operatively couple with the device electrical contact when the battery is in the locked position.

The device may include a seal. The seal may be constructed to create a seal between the device bottom and the device-facing major surface of the battery. The seal may be constructed to create a seal around a contact region between the device electrical contact and the battery electrical contact.

The raised portion of the spacer may be constructed to protect the electrical contacts and the seal from wear or damage that could be caused by the movement of the battery relative to the device. The ramp of the spacer may be constructed to allow the battery to slide toward the bottom of the recess in order to engage the front guide elements.

The front guide elements may include a locking mechanism. Alternatively, or in addition, the bottom of the recess may include a locking clip and the bottom of the battery may include a groove constructed to receive the locking clip. The locking mechanism may be constructed to provide sensory feedback of the locking elements becoming engaged.

### BRIEF DESCRIPTION OF FIGURES

FIG. 1A is a plan view of a system according to an embodiment.

FIGS. 1B and 1C are perspective views of the system of FIG. 1A according to an embodiment.

FIGS. 2A and 2B are exploded views of the system of FIG. 1A according to an embodiment.

FIG. 3A is an exploded plan view of the system of FIG. 1A according to an embodiment.

FIG. 3B is an exploded cross-sectional side view of the system of FIG. 3A according to an embodiment.

FIG. 4 is a side-by-side view of the components of the system of FIG. 1A according to an embodiment.

FIG. 5 is a simplified schematic of a cross-sectional side view of the components of the system of FIG. 1A according to an embodiment.

FIG. 6A is a plan view of the system of FIG. 1A according to an embodiment.

FIG. 6B is cross-sectional side view of the system of FIG. 6A according to an embodiment.

FIGS. 6C and 6D are detail views of the system of FIG. 6B according to an embodiment.

FIG. 7A is a side view of a battery of the system of FIG. 1A according to an embodiment.

FIG. 7B is a side view of a front guide element of the battery of FIG. 7A according to an embodiment.

FIG. 7C is a cross-sectional top view of a front guide element of the battery of FIG. 7A according to an embodiment.

FIG. 7D is a partial side view of a back guide element of the battery of FIG. 7A according to an embodiment.

FIG. 8A is a side view of the system of FIG. 1A according to an embodiment.

FIB. 8B is a cross-sectional top view of the system of FIG. 8A according to an embodiment.

FIG. 8C is a detail view of the system of FIG. 8B according to an embodiment.

FIG. 9 is a perspective view of a system according to an embodiment.

FIGS. 10A and 10B are exploded views of the system of FIG. 9 according to an embodiment.

FIG. 11A is a bottom view of the battery of the system of FIG. 9 according to an embodiment.

FIG. 11B is a perspective view of the battery of FIG. 11A.

FIG. 12A is an exploded plan view of the system of FIG. 9 according to an embodiment.

FIG. 12B is an exploded cross-sectional side view of the system of FIG. 12A according to an embodiment.

FIG. 13A is a plan view of the system of FIG. 9 according to an embodiment.

FIG. 13B is cross-sectional side view of the system of FIG. 13A according to an embodiment.

FIG. 13C is a detail view of the system of FIG. 13B according to an embodiment.

### DEFINITIONS

All scientific and technical terms used herein have meanings commonly used in the art unless otherwise specified. The definitions provided herein are to facilitate understanding of certain terms used frequently herein and are not meant to limit the scope of the present disclosure.

The term “ramp” is used here to refer to a structure with a surface that has a slope relative to a floor or bottom or to a general direction of movement.

The term “substantially” as used here has the same meaning as “significantly,” and can be understood to modify the term that follows by at least about 90%, at least about 95%, or at least about 98%. The term “not substantially” as used here has the same meaning as “not significantly,” and can be understood to have the inverse meaning of “substantially,” i.e., modifying the term that follows by not more than 10%, not more than 5%, or not more than 2%.

The term “about” is used here in conjunction with numeric values to include normal variations in measurements as expected by persons skilled in the art, and is understood have the same meaning as “approximately” and to cover a typical margin of error, such as ±5% of the stated value.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

As used here, “have”, “having”, “include”, “including”, “comprise”, “comprising” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method or the like, means that the components of the composition, product, method or the like are limited to the enumerated components and any other components that do not materially affect the basic and novel characteristic(s) of the composition, product, method or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Any direction referred to here, such as “front,” “back,” “top,” “bottom,” “left,” “right,” “upper,” “lower,” and other directions and orientations are described herein for clarity in reference to the figures and are not to be limiting of an actual device or system or use of the device or system. Specifically, the term “front” with regard to the battery is used here to describe the end of the battery that is first advanced into the recess of the device to couple the battery with the device. The term “forward” is used to describe a direction of movement led by the front and/or toward the device. The term “back” with regard to the battery is used here to describe the end opposite of the front. The term “backward” is used to describe a direction of movement led by the back and/or away from the device. Devices or systems as described herein may be used in a number of directions and orientations.

### Detailed Description

The present disclosure relates to a slide mechanism for removably attaching a battery to an electrically powered device. The present disclosure further relates to a battery-powered system including a device with such a slide mechanism, and a battery constructed to be removably coupled with the device via the slide mechanism.

Various electrically powered devices may include a battery that is removable from the device. In some cases, the device may include tracks, and the battery may be slid along the tracks to guide the battery into place and provide secure attachment. However, sliding the battery off and on may cause wear and damage to the electrical contacts between the battery and the device. In particular, in cases where a close fit (e.g., a waterproof fit) is desired between the battery and the device, the electrical contacts of the battery and/or the device may come into contact with each other or with parts of the battery or device while the battery is being moved, further increasing the risk of damage to the electrical contacts. In devices that include a seal, the seal may also come into contact with parts of the battery or device while the battery is being moved and may be subject to wear or damage.

It would be desirable to provide a battery-powered system including a battery-powered device and a battery, where the battery may be slid along a spacer to engage the electrical contact of the battery with the electrical contact of the device, and where the spacer protects the electrical contacts against wear and damage while the battery is moved. It would further be desirable to provide a battery-powered system with a sealed contact between electrical contacts of the battery and the device. It would also be desirable to provide the battery-powered system with a seal and a spacer that protects the seal against wear and damage while the battery is moved.

The device may be any suitable battery-powered device. In some embodiments, the device is a system control unit. In some embodiments, the device is a communications device, such as a hand-held two-way radio or a cellular phone, or another battery-powered device, such as a camera. According to an embodiment, the device includes an electrical contact constructed to mate with the electrical contact of the battery. In some embodiments, the electrical contact of the device may include spring pin connectors. In some embodiments, the electrical contact of the device includes a circuit board, such as a flexible circuit board. The battery may be any suitable rechargeable (e.g., secondary) battery or battery pack. According to an embodiment, the battery is encased in a plastic casing or shell with one or more electrical contacts constructed to mate with the electrical contact of the device. In some embodiments, the electrical contact of the battery may include a circuit board, such as a flexible circuit board. In some embodiments the battery includes spring pin electrical contacts.

According to an embodiment, the system includes a seal that is constructed to seal around the electrical contact region between the device and the battery. Any suitable seal may be used, such as a rubber gasket. The seal may create a seal around the electrical contact region when the battery is engaged with one or more locking mechanisms of the device. The electrical contact region is the area where the electrical contacts of the device and battery are disposed and may come into contact with one another.

According to an embodiment, the system includes a sliding mechanism with a spacer that allows the battery to slide above the electrical contact of the device when the battery is moved along the spacer. The battery may be moved along the spacer to be received in a recess of the device. According to an embodiment, the battery does not contact the electrical contact of the device when the battery is moved along the sliding mechanism. The battery is moved along the sliding mechanism for a move distance. The move distance may be considered to be the length of the recess. After the front of the battery has been moved past the electrical contact of the device, the front of the battery may be moved downward toward the bottom of the recess along a sloping surface or ramp. Once the front of the battery reaches the bottom of the recess, the guide elements and a locking mechanism may engage. The battery may be moved 40% or more, 50% or more, or about 60% of the move distance before sliding down on the ramp. According to an embodiment, the battery does not contact the electrical contact of the device along at least 80%, at least 85%, at least 90%, at least 95%, or at least 98% of the move distance of the battery when the battery is moved along the sliding mechanism.

According to an embodiment, the system includes a sliding mechanism that provides an audible click or other sensory feedback as the battery is slid into a locked position to provide verification that the battery is engaged and locked.

According to an embodiment, the system includes guide elements near the front and the back of the battery to provide a secure fit. The system may include one or more locking features. The one or more locking features may include a post or a clip on the device and a corresponding recess on the battery to receive the post or clip.

Reference is made now to the drawings that demonstrate a system with an exemplary device (e.g., a communications device) and battery that includes a sliding mechanism according to embodiments of the present disclosure.

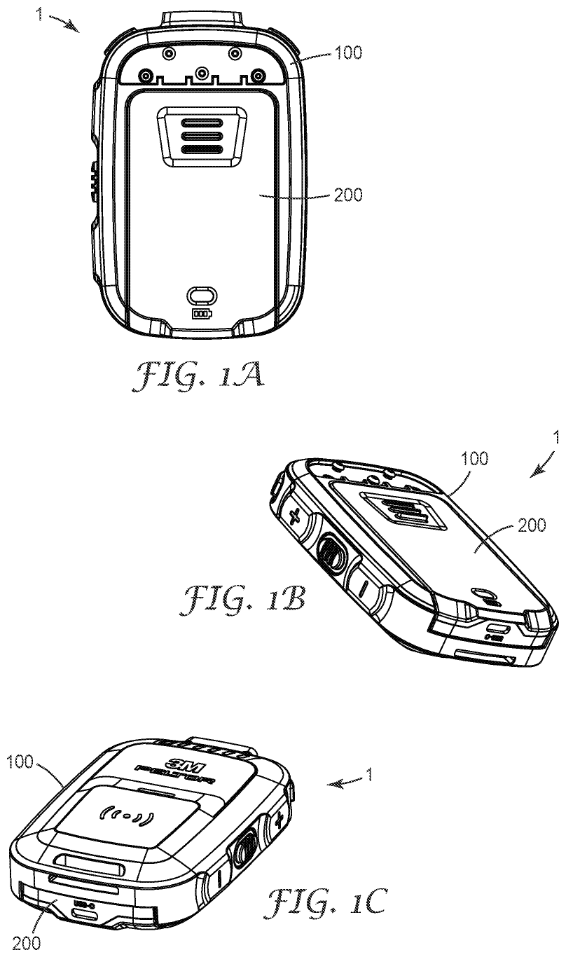

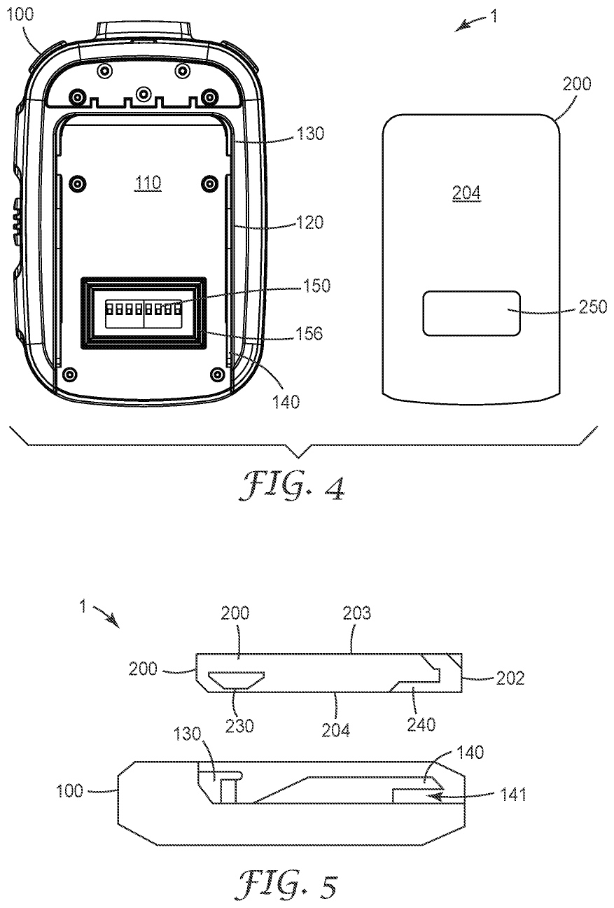

FIGS. 1A-1C show the system 1 with a device 100 and a battery 200 for supplying power to the device 100. In the exemplary embodiment shown, the device 100 is a hand-held communications device. The battery 200 is coupled with the device 100 to secure the battery to the device 100 and to operably engage the electrical contact 250 of the battery with the electrical contact 150 of the device (see also FIG. 4). When the battery 200 is locked in place, it may form at least a portion of the wall of the device 100.

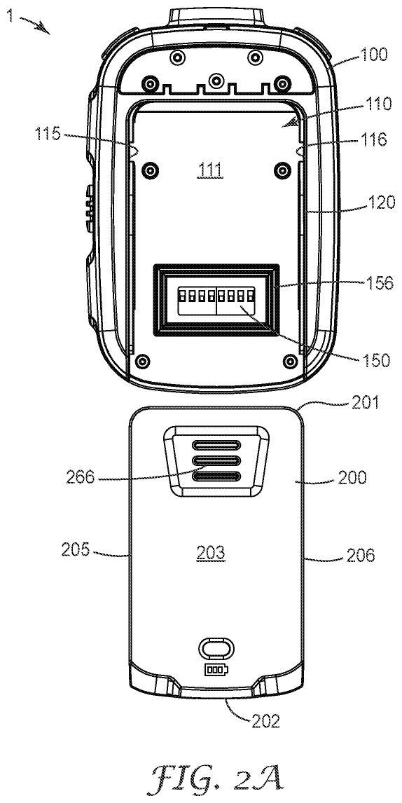

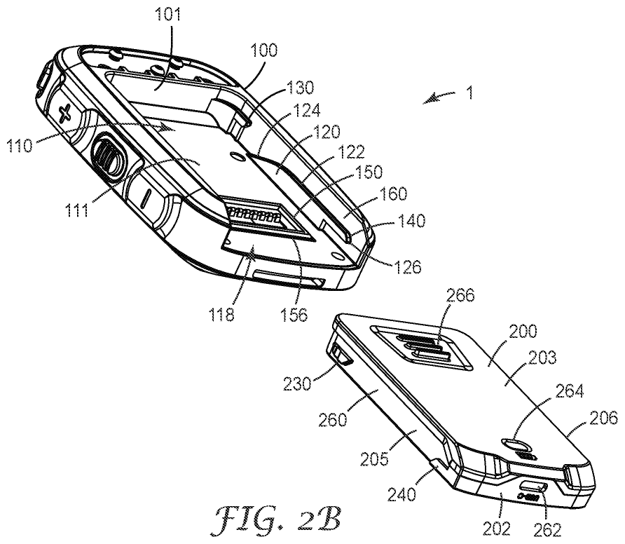

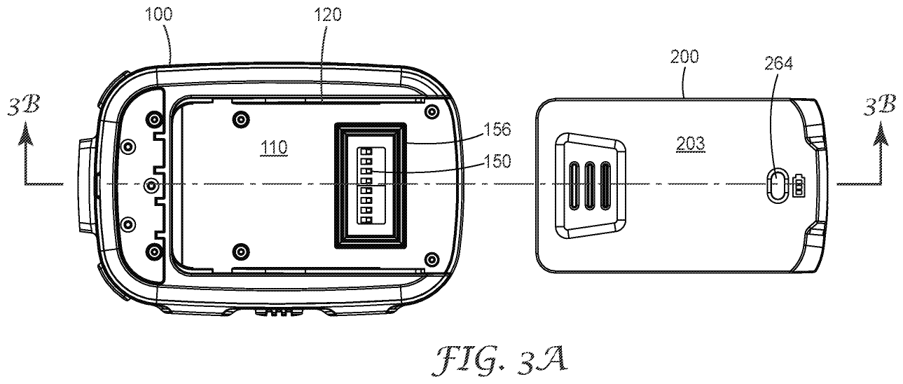

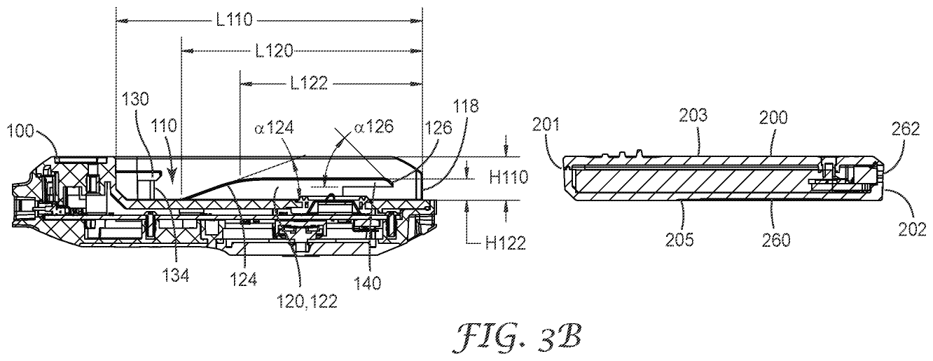

As shown in FIGS. 2A-5, the device 100 has a recess 110 for receiving the battery 200. The recess 110 defines a bottom 111 and opposing first and second sides 115, 116. The recess 110 has a length L110 along a longitudinal axis in a front-to-back direction (see FIG. 3B). The device 100 includes an electrical contact 150 disposed at the bottom 111 of the recess 110.

The device 100 includes a spacer 120 that is constructed to guide the battery 200 into a locked position. Preferably, the device 100 includes a spacer 120 at both sides 115, 116 of the recess 110. The device 100 may be symmetrical about a longitudinal (front-to-back) axis with regard to the sliding mechanism, including the spacers and guide elements along the sides of the recess 110. Thus, when reference is made here to a spacer 120, it may be inferred that the description applies to the spacers 120 at both sides of the recess 110. The spacer 120 may be a protrusion extending inward into the recess 110 from the first and second sides 115, 116. The spacer 120 includes a raised portion 122. The raised portion 122 may be aligned in a front-to-back direction with the electrical contact 150 of the device 100. That is, the raised portions 122 are disposed along both sides of the electrical contact 150. The device 100 includes guide elements 130, 140 disposed at each of the first and second sides 115, 116. The guide elements 130, 140 at each side include a front guide element 130 and a back guide element 140. The spacer 120 further includes a first ramp 124 disposed between the raised portion 122 of the spacer 120 and the front guide element 130.

The battery has a front end 201, a back end 202 opposite of the front end 201, and opposing first and second sides 205, 206. The battery further has a top surface 203 and a bottom surface 204 which is the device-facing major surface. The bottom surface 204 (device-facing major surface) is bordered by the front end 201, back end 202, and first and second sides 205, 206. The battery 200 includes front guide elements 230 and back guide elements 240 disposed at each of the first and second sides 205, 206. The front guide elements 230 and back guide elements 240 are constructed to mate with the front guide elements 130 and back guide elements 140 of the device, respectively. When the front guide elements 130, 230 and back guide elements 140, 240 are mated, the battery 200 is in a locked position as shown in FIGS. 1A-1C.

The battery includes an electrical contact 250 disposed along the device-facing major surface (the bottom surface 204), as seen in FIG. 4. The battery electrical contact 250 is constructed to operatively engage with the device electrical contact 150 when the battery 200 is in the locked position.

According to an embodiment, the device 100 further includes a seal 156. The seal 156 may be attached to the bottom 111 of the recess 110, surrounding the electrical contact 150 of the device 100. Alternatively, the seal 156 may be attached to the bottom surface 204 of the battery 200. The seal 156 is constructed to create a seal between the device bottom 111 and the bottom surface 204 of the battery 200 when the battery 200 is in the locked position. The seal 156 may be constructed to create a seal around a contact region between the device electrical contact 150 and the battery electrical contact 250. The contact region is the area where the electrical contacts 150, 250 of the device 100 and battery 200 are disposed and may come into contact with one another.

Any suitable electrical contacts may be used on the device 100 and the battery 200. While reference is made here to a single electrical contact, the electrical contact of either the device 100 or the battery 200 or both may include a plurality of electrical contacts. In one embodiment, the device electrical contact 150 includes a plurality of spring pins. The plurality of spring pins may form a line along the bottom 111 of the device 100, as shown. The line may be disposed orthogonal to the sides 115, 116 of the recess 110. In one embodiment, the battery electrical contact 250 includes a circuit board, such as a flexible circuit board. The circuit board may be disposed along the bottom surface 204 (device-facing major surface). In some embodiments, the spring pins are on the battery and the flexible circuit board is on the device.

According to an embodiment, the sliding mechanism (e.g., the spacer 120) is constructed to prevent parts of the battery 200, other than the battery electrical contact 250, from contacting the device electrical contact 150. The battery 200 may be slid into the recess 110 of the device 100 along the spacers 120. The raised portion 122 of the spacer 120 has a height H122 (see FIG. 3B) that is greater than the height of the electrical contact 150, measured from the bottom 111 of the recess 110. Thus, the raised portion 122 maintains the battery 200 at a height that does not allow the battery 200 to contact the electrical contact 150 while sliding along the raised portion 122. The height H122 of the raised portion 122 is less than the height H110 of the recess 110. For example, the height H122 of the raised portion 122 may be 25% or more, 30% or more, or 40% or more of the height H110 of the recess 110. The height H122 of the raised portion 122 may be 75% or less or 60% or less of the height H110 of the recess 110. The height H122 of the raised portion 122 may be from 25% to 75%, from 40% to 60%, or about 50% of the height H110 of the recess 110.

Toward the end of the sliding movement of the battery 200, the first ramp 124 guides first end 201 of the battery 200 downward toward the bottom 111 of the recess 110. When the first end 201 of the battery 200 reaches the end of the first ramp 124, the front guide elements 230 of the battery 200 may engage the front guide elements 130 of the device 100.

While the battery 200 is being moved relative to the device 100, the battery 200 does not contact the electrical contact 150 of the device 100 until at the very end of the sliding movement, where the electrical contact 250 of the battery 200 may come into contact with the electrical contact 150 of the device 100. According to an embodiment, the battery 200 does not contact the electrical contact 150 of the device 100 along at least 90%, at least 95%, or at least 98% of the move distance of the battery 200 when the battery 200 is moved along the spacers 120. The move distance may be considered to be the length L110 of the recess 110.

The first ramp 124 may have a sloped surface that is at an angle α124 relative to the bottom 111 of the recess 110. The angle α124 is greater than 0 degrees and less than 90 degrees. The angle α124 may be 5 degrees or greater, 10 degrees or greater, or 15 degrees or greater. The angle α124 may be 60 degrees or less, 50 degrees or less, 40 degrees or less, or 30 degrees or less. In some embodiments, the angle α124 is from 10 degrees to 45 degrees, from 10 degrees to 30 degrees, from 15 degrees to 25 degrees, or about 20 degrees.

The raised portion 122 may have a length L122 as measured from the open end 118 of the recess 110 (see FIG. 3B). The length L122 of the raised portion 122 may be 40% or more, 50% or more, or about 60% of the length L110 of the recess 110. This means that the battery 200 may be moved 40% or more, 50% or more, or about 60% of the move distance (equal to the length L110 of the recess 110) before sliding down on the ramp 124. According to an embodiment, the battery 200 does not contact the electrical contact 150 of the device 100 along at least 90%, at least 95%, or at least 98% of the move distance of the battery 200 when the battery 200 is moved along the sliding mechanism.

The combined length of the raised portion 122 and the first ramp 124 may be the length L120 of the spacer 120, measured from the open end 118 of the recess 110 (see FIG. 3B).

The spacer 120 may include additional sloped surfaces (e.g., ramps) to help guide the movement of the battery 200. For example, the spacer 120 may include a second ramp 126 opposite of the first ramp 124. The second ramp 126 may be disposed at the end of the spacer 120 facing toward the open end 118 of the recess 110, as seen in FIG. 2B. The second ramp 126 may help with the insertion of the battery 200 and guiding the battery 200 onto the spacer 120. The second ramp 126 may have a sloped surface that is at an angle α126 relative to the bottom 111 of the recess 110, shown in FIG. 3B. The angle α126 is greater than 0 degrees and less than 90 degrees. The angle α126 may be 10 degrees or greater, 20 degrees or greater, 30 degrees or greater, or 40 degrees or greater. The angle α126 may be 80 degrees or less, 70 degrees or less, 60 degrees or less, or 50 degrees or less. In some embodiments, the angle α126 is from 30 degrees to 60 degrees, from 40 degrees to 50 degrees, or about 45 degrees.

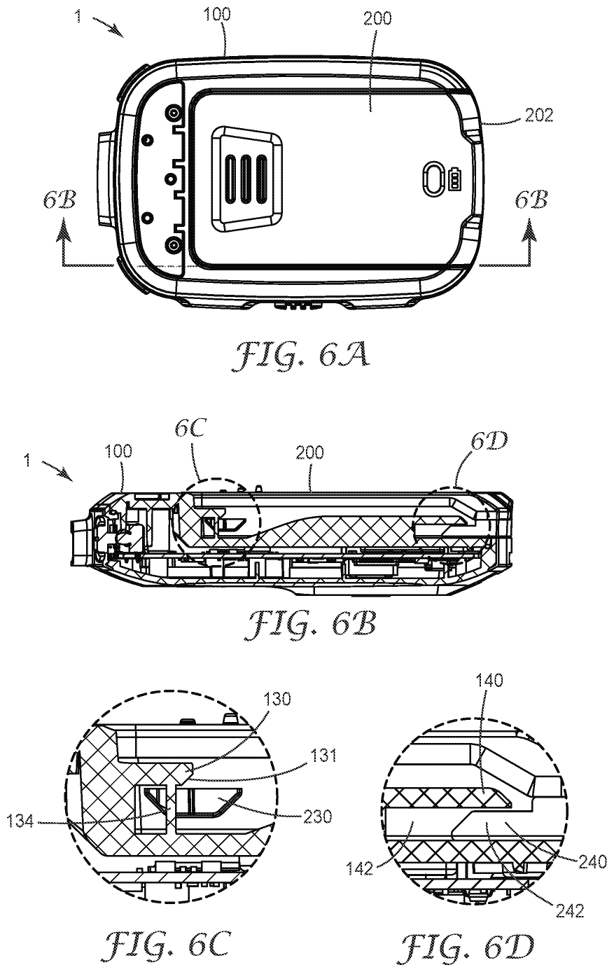

The sliding mechanism may include a third ramp 131 that may help guide the front guide element 230 of the battery 200 into the front guide element 130 of the device 100. The third ramp 131 may be part of the front guide element 130, as shown in FIG. 6C.

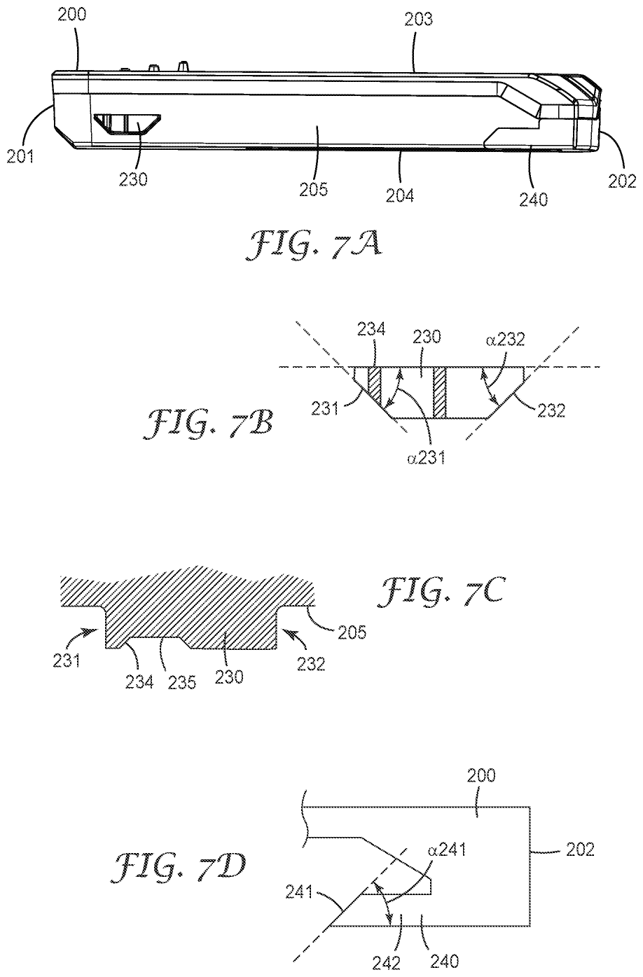

The front and back guide elements 230, 240 of the battery 200 may also include sloped surfaces that help guide the movement of the battery 200 into and out of the recess 110, as shown in FIGS. 7A-7D. The front guide element 230 of the battery 200 may include a forward sloping surface 231 constructed to engage the second ramp 126 of the device 100 when the battery is being slid forward into the recess 110. The forward sloping surface 231 may have a sloped surface that is at an angle α231 relative to the bottom surface 204. The angle α231 is greater than 0 degrees and less than 90 degrees. The angle α231 may be 10 degrees or greater, 20 degrees or greater, 30 degrees or greater, or 40 degrees or greater. The angle α231 may be 80 degrees or less, 70 degrees or less, 60 degrees or less, or 50 degrees or less. In some embodiments, the angle α231 is from 30 degrees to 60 degrees, from 40 degrees to 50 degrees, or about 45 degrees.

The front guide element 230 of the battery 200 may include a backward sloping surface 232 constructed to engage the first ramp 124 when the battery 200 is being slid backward away from the recess 110. The backward sloping surface 232 may have a sloped surface that is at an angle α232 relative to the bottom surface 204 (or a plane parallel to the bottom surface 204, such as the top of the front guide element 230 as shown in FIG. 7B). The angle α232 is greater than 0 degrees and less than 90 degrees. The angle α232 may be 10 degrees or greater, 20 degrees or greater, 30 degrees or greater, or 40 degrees or greater. The angle α232 may be 80 degrees or less, 70 degrees or less, 60 degrees or less, or 50 degrees or less. In some embodiments, the angle α232 is from 30 degrees to 60 degrees, from 40 degrees to 50 degrees, or about 45 degrees.

The back guide element 240 of the battery 200 may include a forward sloping surface 241, shown in FIG. 7D, constructed to engage the back guide element 140 of the device 100 when the battery is being slid forward into the recess 110. The forward sloping surface 241 may have a sloped surface that is at an angle α241 relative to the bottom surface 204. The angle α241 is greater than 0 degrees and less than 90 degrees. The angle α241 may be 10 degrees or greater, 20 degrees or greater, 30 degrees or greater, or 40 degrees or greater. The angle α241 may be 80 degrees or less, 70 degrees or less, 60 degrees or less, or 50 degrees or less. In some embodiments, the angle α241 is from 30 degrees to 60 degrees, from 40 degrees to 50 degrees, or about 45 degrees.

The guide elements 130, 140 of the device 100 and the guide elements 230, 240 of the battery 200 are shown in detail in FIGS. 3B, 5, 6B-6D, 7B-7D, and 8B-8C. According to embodiments, the front guide elements 230 of the battery 200 are constructed to mate with the front guide elements 130 of the device 100. The back guide elements 240 of the battery 200 are constructed to mate with the back guide elements 140 of the device.

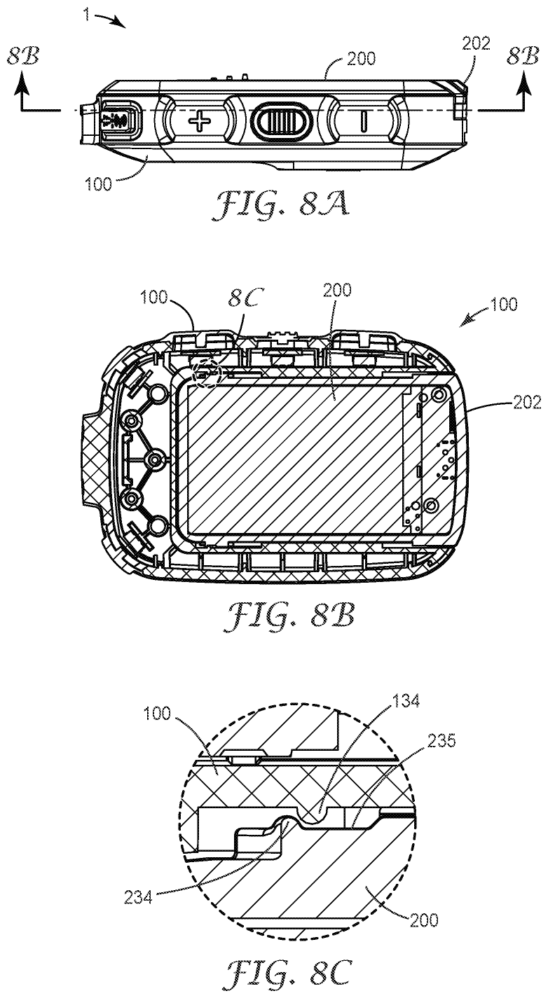

Referring now to FIGS. 6B, 6C, 7B, and 7C, the front guide element 130 of the device 100 may include a vertical locking element, such as a locking post 134, orthogonal to the bottom 111. The front guide element 230 of the battery 200 may include a locking surface 234 constructed to mate with the front guide element 130 (e.g., the locking post 134) of the device 100. The locking surface 234 may form a recess 235, as shown in FIG. 7C. The recess 235 may be configured to receive the locking post 134, as shown in FIG. 8C. The locking post 134 and the front guide element 230 of the battery 200 may be constructed to provide an audible “click” when the front guide elements 130, 230 engage one another as shown in FIGS. 8B and 8C.

The back guide element 140 of the device 100 may form a slot 142 parallel to the bottom 111. The back guide element 240 of the battery 200 may include an arm 242 constructed to slide into the slot 142, as shown in FIGS. 6B and 6D.

The back guide element 140 and the spacer 120 of the device 100 may be integrally formed. That is, the back guide element 140 may form a part of the spacer 120 of the device. The device 100 may include parts made from various materials. The device 100 may include a frame 160 (see FIG. 2B) constructed of plastic, such as molded plastic. The front and back guide elements 130, 140 and the spacer 120 may be integrally formed with the frame 160 of the device.

The battery 200 may include an outer shell 260 (see FIG. 2B). The front and back guide elements 230, 240 of the battery 200 may be integrally formed with the outer shell 260 or a portion of the outer shell 260. The outer shell 260 of the battery 200 may be made of any suitable material, for example, plastic, such as molded plastic.

The battery 200 may optionally include additional features, such as a charging port 262, an indicator light 264, finger grip 266, or a combination thereof, as shown in FIGS. 2A and 2B. The charging port 262 may be disposed at any suitable location, such as the back end 202. Locating the charging port 262 at the back end 202 allows the battery 200 to be charged whether engaged with the device 100 or not. The indicator light 264 may be configured to indicate a charge level and/or the need to charge the battery. The finger grip 266 may be provided to help move the battery 200 along the spacer 120. The finger grip 266 may include, for example, one or more raised features on the outer surface of the battery 200.

The device 100 may also include various additional features depending on the intended purpose and use of the device. In an exemplary embodiment as shown in the figures, the device 100 is a hand-held communications device and may include various buttons and controls to operate the device 100. The device 100 may also include various other components associated with such devices, such as one or more programmable processors that include processing capabilities (for example, microcontrollers or programmable logic devices), data storage (for example, volatile or non-volatile memory or storage elements), input devices, and output devices, as well as one or more computer programs executed on such processors. The device 100 may also include a microphone, a speaker, and other additional features to facilitate use of the device 100 as a communications device.

According to an embodiment, a method of using the system of the present disclosure may include advancing the front end 201 of the battery 200 into the recess 110 and sliding the battery 200 along the spacer 120. Once the front end 201 reaches the first ramp 124, the front end 201 may be slid down along the first ramp 124 until the front guide elements 230 of the battery 200 reach the front guide elements 130 of the device 100. The back guide elements 240 of the battery 200 may begin sliding into the back guide elements 140 of the device 100. The battery 200 may be further pushed forward until both the front guide elements 130, 230 and the back guide elements 140, 240 are fully engaged. The front guide elements 130, 230 may provide a sensory signal, such as an audible “click,” to verify that the guide elements are fully engaged and the battery 200 is locked in place. A seal may be formed between the battery 200 and the device 100 at the seal 156 surrounding the electrical contacts 150, 250.

The battery 200 may be removed by pulling the battery 200 backward, thus disengaging the front guide elements 130, 230 and the back guide elements 140, 240. The battery 200 may slide upward along the first ramp 124 to avoid contact with the electrical contact 150 of the device 100 during movement.

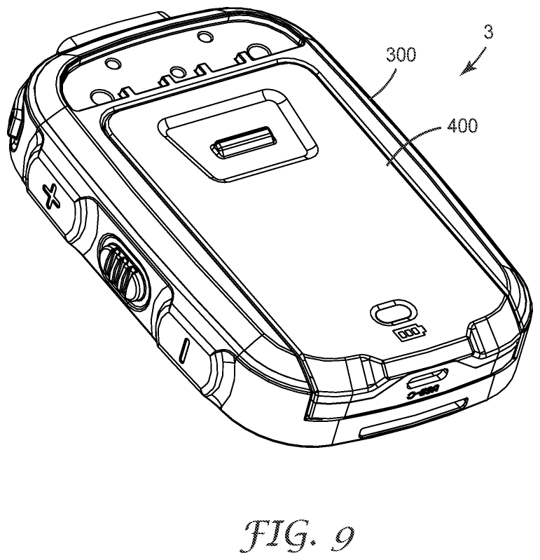

FIGS. 9-13C show an embodiment that is similar to the embodiment shown in FIGS. 1A-8C. In the embodiment shown in FIGS. 9-13C, the locking mechanism is provided at the bottom of the recess on the device and at the device-facing major surface of the battery. The materials, general construction, and additional features of the device and battery may be as described with regard to FIGS. 1A-8C.

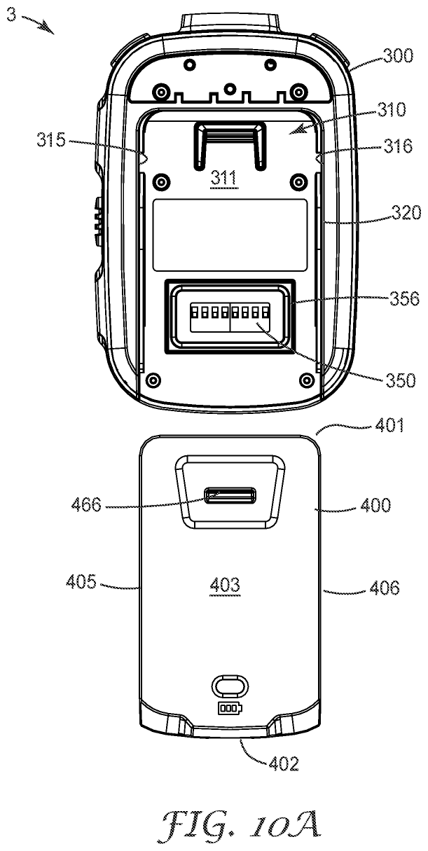

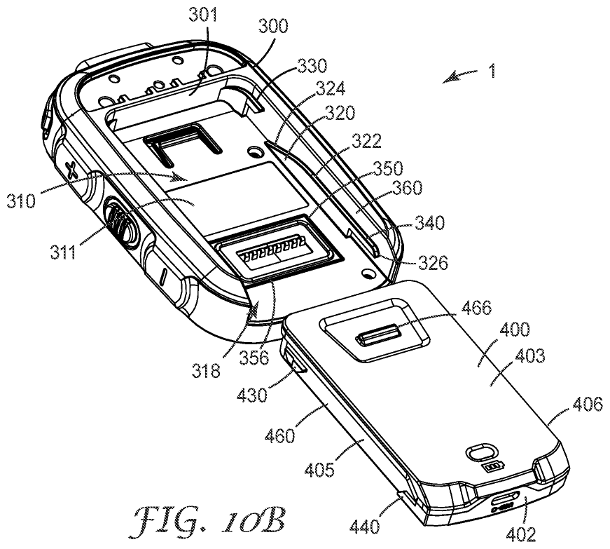

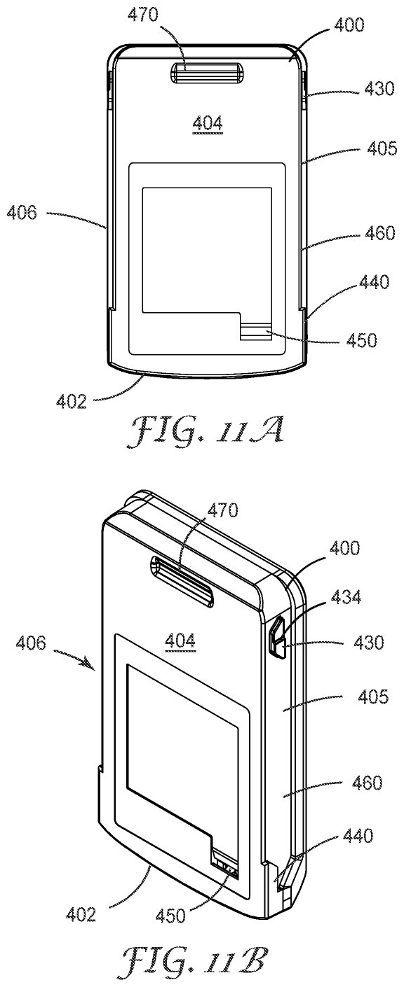

FIGS. 9 and 10A-10B show the system 3 with a device 300 and a battery 400 for supplying power to the device 300. The battery 400 is coupled with the device 300 to secure the battery to the device 300 and to operably engage the electrical contact 450 of the battery 400 with the electrical contact 350 of the device 300. When the battery 400 is locked in place, it may form at least a portion of the wall of the device 300.

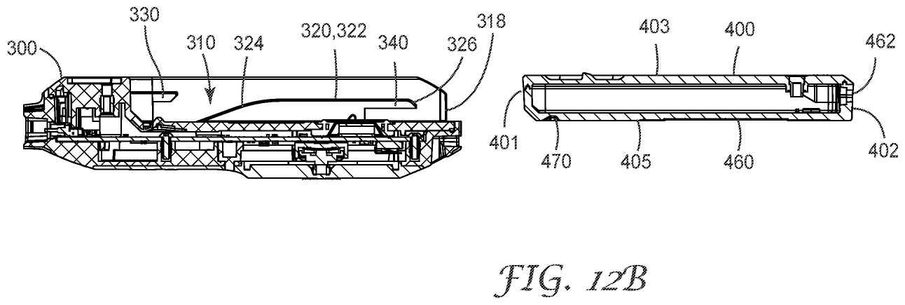

As shown in FIGS. 10A-10B and 12A-12B, the device 300 has a recess 310 for receiving the battery 400. The recess 310 defines a bottom 311 and opposing first and second sides 315, 316. The device 300 includes an electrical contact 350 disposed at the bottom 311 of the recess 310.

As with the device 100 of FIGS. 1A-8C, the device 300 includes a spacer 320 that is constructed to guide the battery 400 into a locked position. The spacer 320 includes a raised portion 322. The device 300 includes front guide elements 330 and back guide elements 340 disposed at each of the first and second sides 315, 316. The spacer 320 further includes a first ramp 324 disposed between the raised portion 322 of the spacer 320 and the front guide element 330, and a second ramp 326 opposite of the first ramp 324. The configuration and functioning of the spacer 320 are described with regard to FIG. 3B. The sliding mechanism may also include a third ramp as described with regard to FIG. 6C.

The battery 400 has a front end 401, a back end 402 opposite of the front end 401, and opposing first and second sides 405, 406. The battery further has a top surface 403 and a bottom surface 404 which is the device-facing major surface. The battery 400 includes front guide elements 430 and back guide elements 440 constructed to mate with the front guide elements 330 and back guide elements 340 of the device, respectively. When the front guide elements 330, 430 and back guide elements 340, 440 are mated, the battery 400 is in a locked position as shown in FIG. 9.

According to an embodiment, the device 300 further includes a seal 356, which may be attached to the bottom 311 of the recess 310, surrounding the electrical contact 350 of the device 300. Alternatively, the seal 356 may be attached to the bottom surface 404 of the battery 400.

The front and back guide elements 430, 440 of the battery 400 may also include sloped surfaces, including a forward sloping surface and a backward sloping surface as described with regard to FIGS. 7A-7D. The back guide elements 340, 440 are further described as described with regard to FIGS. 6B and 6D.

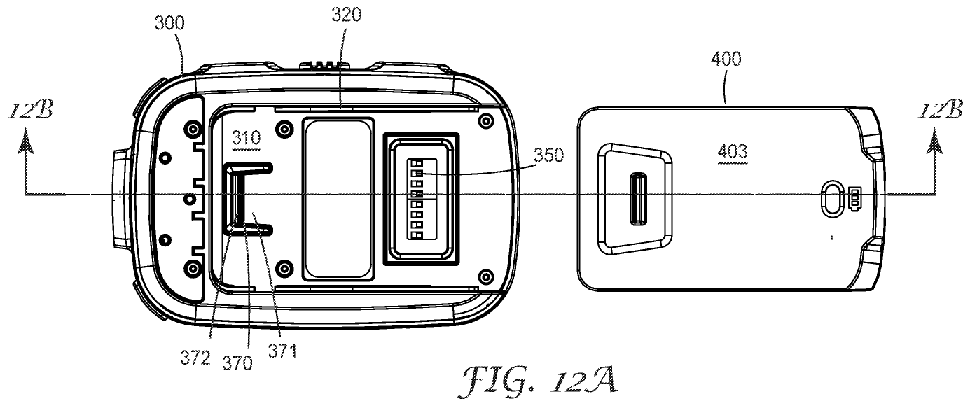

Referring now to FIG. 10B, the front guide element 330 of the device 300 may be similar to the front guide element 330 in FIGS. 6B and 6C except that the front guide element 330 does not include a vertical locking element. The front guide element 430 of the battery 400, shown in FIG. 11B, may be otherwise similar to the front guide element 230 in FIGS. 7A-7C except that the front guide element 430 does not include a locking surface 234 or a recess 235. Instead, the front guide element 430 of the battery 400 may include a forward-facing stopping surface 434. The stopping surface 434 may abut against a backward-facing edge of the front guide element 330 of the device when the battery 400 is in a locked position.

According to an embodiment, the device 300 includes a locking clip 370 and the battery 400 comprises a corresponding groove 470 constructed to receive the locking clip 370, as shown in FIGS. 11A-12B. The locking clip 370 may be disposed along the bottom 311 of the recess 310. The groove 470 may be disposed along the bottom surface 404 (the device-facing major surface) of the battery 400.

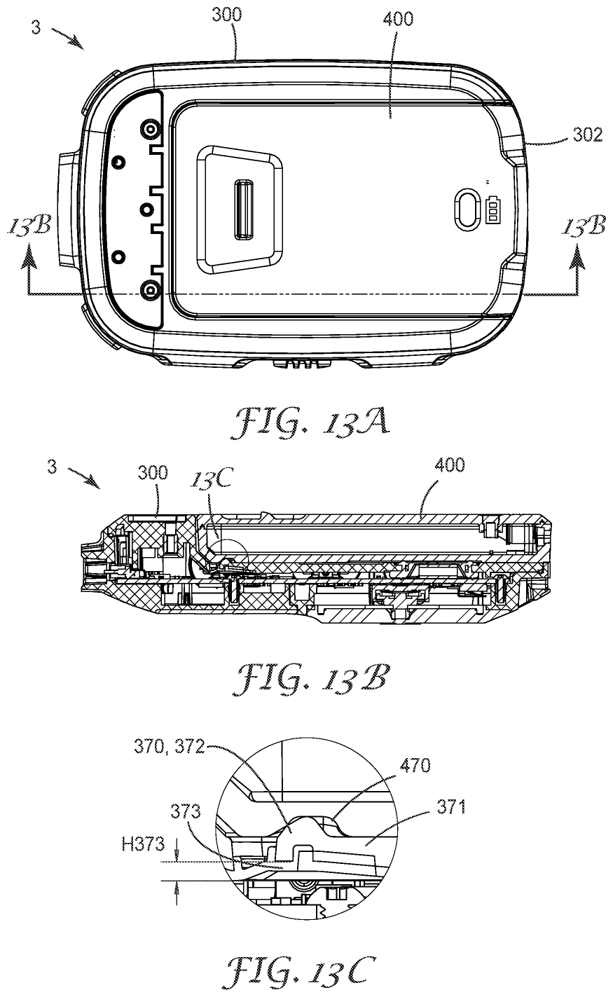

The locking clip 370 may include a spring arm 371 extending from the bottom 311 of the recess 310, and a protrusion 372 at the free end of the spring arm 371. A cross-sectional detail view of the locking mechanism is shown in FIG. 13C. The spring arm 371 may extend above the surface below the spring arm 371, providing a clearance 373 having a height H373. The clearance 373 allows the spring arm 371 to flex as the battery 400 is pushed into place. When the battery 400 and the device 300 are in a locked position, the protrusion 372 is received in the groove 470 of the battery 400. The locking mechanism may be constructed to provide an audible “click” when the protrusion 372 and the groove 470 engage.

According to an embodiment, a method of using the system of the present disclosure may include advancing the front end 401 of the battery 400 into the recess 310 and sliding the battery 400 along the spacer 320. Once the front end 401 reaches the first ramp 324, the front end 401 may be slid down along the first ramp 324 until the front guide elements 430 of the battery 400 reach the front guide elements 330 of the device 300. The back guide elements 440 of the battery 400 may begin sliding into the back guide elements 340 of the device 300. The battery 400 may be further pushed forward until both the front guide elements 330, 430 and the back guide elements 340, 440 are fully engaged and the locking mechanism (locking clip 370 and groove 470) engage. The locking mechanism (locking clip 370 and groove 470) may provide a sensory signal, such as an audible “click,” to verify that the guide elements are fully engaged and the battery 400 is locked in place. A seal may be formed between the battery 400 and the device 300 at the seal 356 surrounding the electrical contacts 350, 450.

The battery 400 may be removed by pulling the battery 400 backward, thus disengaging the locking mechanism (locking clip 370 and groove 470), the front guide elements 330, 430, and the back guide elements 340, 440. The battery 400 may slide upward along the first ramp 324 to avoid contact with the electrical contact 350 of the device 300 during movement.

### Illustrative Embodiments

According to a first embodiment, a battery-powered system comprises a device and a battery for supplying power to the device, the device comprising: a recess for receiving the battery, the recess defining a bottom and opposing first and second sides; and a device electrical contact disposed at the bottom of the recess. Disposed at each of the first and second sides are a front guide element; a back guide element; and a spacer comprising a raised portion aligned with the device electrical contact and a first ramp disposed between the raised portion and the front guide element. The battery defines a front end, a back end opposite of the front end, opposing first and second sides, and a device-facing major surface, the battery comprising: disposed at each of the first and second sides, a front guide element and a back guide element, the front and back guide elements constructed to mate with the front and back guide elements of the device, respectively, such that when the front and back guide elements are mated, the battery is in a locked position; and a battery electrical contact disposed along the device-facing major surface, constructed to operatively couple with the device electrical contact when the battery is in the locked position.

Embodiment 2 is the battery-powered system of embodiment 1, where the device further comprises a seal. The seal may be a rubber gasket.

Embodiment 3 is the battery-powered system of embodiment 1 or 2, wherein the seal is constructed to create a seal between the device bottom and the device-facing major surface of the battery.

Embodiment 4 is the battery-powered system of embodiment 2, wherein the seal is constructed to create a seal around a contact region between the device electrical contact and the battery electrical contact. The contact region is the area where the electrical contacts of the device and battery are disposed and may come into contact with one another.

Embodiment 5 is the battery-powered system of any one of embodiments 1 to 4, wherein the device electrical contact comprises a plurality of spring pins. The plurality of spring pins may form a line along the bottom of the device. The line may be disposed orthogonal to the sides of the recess.

Embodiment 6 is the battery-powered system of any one of embodiments 1 to 5, wherein the front guide element of the device comprises a locking post orthogonal to the bottom. The front guide element of the battery comprises a recess configured to receive the locking post.

Embodiment 7 is the battery-powered system of any one of embodiments 1 to 6, wherein the back guide element of the device and spacer of the device are integrally formed.

Embodiment 8 is the battery-powered system of any one of embodiments 1 to 7, wherein the back guide element of the device comprises a slot parallel to the bottom.

Embodiment 9 is the battery-powered system of any one of embodiments 1 to 8, wherein the spacer prevents parts of the battery other than the battery electrical contact from contacting the device electrical contact. According to an embodiment, the battery does not contact the electrical contact of the device along at least 90%, at least 95%, or at least 98% of the move distance of the battery when the battery is moved along the sliding mechanism.

Embodiment 10 is the battery-powered system of any one of embodiments 1 to 9, wherein the spacer comprises a second ramp opposite of the first ramp.

Embodiment 11 is the battery-powered system of embodiment 10, wherein the front guide element of the battery comprises a forward sloping surface constructed to engage the second ramp when the battery is being slid forward into the recess.

Embodiment 12 is the battery-powered system of any one of embodiments 1 to 11, wherein the front guide element of the battery comprises a backward sloping surface constructed to engage the first ramp when the battery is being slid backward away from the recess.

Embodiment 13 is the battery-powered system of any one of embodiments 1 to 12, wherein the front guide element of the battery comprises a locking surface constructed to mate with the front guide element of the device.

Embodiment 14 is the battery-powered system of any one of embodiments 1 to 13, wherein the back guide element of the device comprises a slot parallel to the bottom and wherein the back guide element of the battery comprises an arm constructed to slide into the slot.

Embodiment 15 is the battery-powered system of any one of embodiments 1 to 14, wherein the battery electrical contact comprises a flexible circuit board.

Embodiment 16 is the battery-powered system of any one of embodiments 1 to 15, wherein the first ramp has an angle of about 10 degrees to 45 degrees relative to the bottom. The first ramp may have a sloped surface that is at an angle greater than 0 degrees and less than 90 degrees. The angle may be 5 degrees or greater, 10 degrees or greater, or 15 degrees or greater. The angle may be 60 degrees or less, 50 degrees or less, 40 degrees or less, or 30 degrees or less. In some embodiments, the angle is from 10 degrees to 30 degrees, from 15 degrees to 25 degrees, or about 20 degrees.

Embodiment 17 is the battery-powered system of any one of embodiments 1 to 16, wherein the second ramp has an angle of less 90 degrees relative to the bottom. The second ramp may have a sloped surface that is at an angle greater than 0 degrees, 10 degrees or greater, 20 degrees or greater, 30 degrees or greater, or 40 degrees or greater. The angle may be 80 degrees or less, 70 degrees or less, 60 degrees or less, or 50 degrees or less. In some embodiments, the angle is from 30 degrees to 60 degrees, from 40 degrees to 50 degrees, or about 45 degrees.

Embodiment 18 is the battery-powered system of any one of embodiments 1 to 17, wherein the front guide element of the device comprises a third ramp, and wherein the third ramp has an angle of less than 90 degrees relative to the bottom.

Embodiment 19 is the battery-powered system of any one of embodiments 1 to 18, wherein the front guide element of the battery comprises a forward sloping surface having an angle of less than 90 degrees relative to the device-facing major surface. The angle may be greater than 0 degrees, 10 degrees or greater, 20 degrees or greater, 30 degrees or greater, or 40 degrees or greater. The angle may be 80 degrees or less, 70 degrees or less, 60 degrees or less, or 50 degrees or less. In some embodiments, the angle is from 30 degrees to 60 degrees, from 40 degrees to 50 degrees, or about 45 degrees.

Embodiment 20 is the battery-powered system of any one of embodiments 1 to 19, wherein the front guide element of the battery comprises a backward sloping surface having an angle of less than 90 degrees relative to the device-facing major surface. The angle may be greater than 0 degrees, 10 degrees or greater, 20 degrees or greater, 30 degrees or greater, or 40 degrees or greater. The angle may be 80 degrees or less, 70 degrees or less, 60 degrees or less, or 50 degrees or less. In some embodiments, the angle is from 30 degrees to 60 degrees, from 40 degrees to 50 degrees, or about 45 degrees.

Embodiment 21 is the battery-powered system of any one of embodiments 1 to 20, wherein the battery comprises a charging port.

Embodiment 22 is the battery-powered system of any one of embodiments 1 to 21, wherein the system comprises a locking mechanism that is constructed to provide a sensory feedback when the battery is locked into place.

Embodiment 23 is the battery-powered system of any one of embodiments 1 to 22, wherein the device comprises a locking clip and the battery comprises a groove constructed to receive the locking clip.

Embodiment 24 is the battery-powered system of embodiment 23, wherein the locking clip is disposed along the bottom of the recess.

Embodiment 25 is the battery-powered system of embodiment 23 or 24, wherein the groove is disposed along the device-facing major surface.

Embodiment 26 is the battery-powered system of any one of embodiments 23 to 25, wherein the locking clip comprises a spring arm and a protrusion disposed at a free end of the spring arm.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

1. A battery-powered system comprising:
a device; and
a battery for supplying power to the device,
the device comprising:
a recess for receiving the battery, the recess defining a bottom and opposing first and second sides;
a device electrical contact disposed at the bottom of the recess; and
disposed at each of the first and second sides:
a front guide element;
a back guide element; and
a spacer comprising a raised portion aligned with the device electrical contact and a first ramp disposed between the raised portion and the front guide element;
the battery defining a front end, a back end opposite of the front end, opposing first and second sides, and a device-facing major surface, the battery comprising:
disposed at each of the first and second sides, a front guide element and a back guide element, the front and back guide elements constructed to mate with the front and back guide elements of the device, respectively, such that when the front and back guide elements are mated, the battery is in a locked position; and
a battery electrical contact disposed along the device-facing major surface, constructed to operatively couple with the device electrical contact when the battery is in the locked position.

2. The battery-powered system of claim 1, the device further comprising a seal, optionally wherein the seal is constructed to create a seal between the device bottom and the device-facing major surface of the battery, further optionally wherein the seal is constructed to create a seal around a contact region between the device electrical contact and the battery electrical contact.

3. The battery-powered system of claim 1, wherein the device electrical contact comprises a plurality of spring pins.

4. The battery-powered system of claim 1, wherein the front guide element of the device comprises a locking post orthogonal to the bottom, optionally wherein the front guide element of the battery comprises a recess configured to receive the locking post.

5. The battery-powered system of claim 1, wherein the device comprises a locking clip and the battery comprises a groove constructed to receive the locking clip, optionally wherein the locking clip is disposed along the bottom of the recess and the groove is disposed along the device-facing major surface.

6. The battery-powered system of claim 5, wherein the locking clip comprises a spring arm and a protrusion disposed at a free end of the spring arm.

7. The battery-powered system of claim 1, wherein the back guide element and spacer of the device are integrally formed.

8. The battery-powered system of claim 1, wherein the back guide element of the device comprises a slot parallel to the bottom.

9. The battery-powered system of claim 1, wherein the spacer prevents parts of the battery other than the battery electrical contact from contacting the device electrical contact.

10. The battery-powered system of claim 1, wherein the spacer comprises a second ramp opposite of the first ramp.

11. The battery-powered system of claim 10, wherein the front guide element of the battery comprises a forward sloping surface constructed to engage the second ramp when the battery is being slid forward into the recess.

12. The battery-powered system of claim 1, wherein the front guide element of the battery comprises a backward sloping surface constructed to engage the first ramp when the battery is being slid backward away from the recess.

13. The battery-powered system of claim 1, wherein the front guide element of the battery comprises a locking surface constructed to mate with the front guide element of the device.

14. The battery-powered system of claim 1, wherein the back guide element of the device comprises a slot parallel to the bottom and wherein the back guide element of the battery comprises an arm constructed to slide into the slot.

15. The battery-powered system of claim 1, wherein the battery electrical contact comprises a flexible circuit board.

16. The battery-powered system of claim 1, wherein the first ramp has an angle of about 10 degrees to 45 degrees relative to the bottom.

17. The battery-powered system of claim 1, wherein the second ramp has an angle of less 90 degrees relative to the bottom.

18. The battery-powered system of claim 1, wherein the front guide element of the device comprises a third ramp, and wherein the third ramp has an angle of less than 90 degrees relative to the bottom.

19. The battery-powered system of claim 1, wherein the front guide element of the battery comprises a forward sloping surface having an angle of less than 90 degrees relative to the device-facing major surface.

20. The battery-powered system of claim 1, wherein the front guide element of the battery comprises a backward sloping surface having an angle of less than 90 degrees relative to the device-facing major surface.
